(19) United States
(12) Patent Application Publication
(10) Pub. No.: US 2026/0213258 A1
(43) Pub. Date: Jul. 23, 2026

(54) SOLID ELECTROLYTE, METHODS FOR PREPARING SAME, AND LITHIUM SECONDARY BATTERY COMPRISING SAME

(71) Applicant: RESEARCH INSTITUTE OF INDUSTRIAL SCIENCE & TECHNOLOGY, Pohang-si (KR)

(72) Inventors: Gwangseok OH, Incheon (KR); Ohmin KWON, Incheon (KR); Sang Cheol NAM, Seoul (KR); Yongsun PARK, Incheon (KR); Bokkyu CHOI, Incheon (KR)

(21) Appl. No.: 19/142,335

(22) PCT Filed: Dec. 23, 2022
(86) PCT No.: PCT/KR2022/021246

§ 371 Date: Jun. 23, 2025

(51) Int. Cl. H01M 10/0562; H01M 10/0525

(52) U.S. Cl. CPC H01M 10/0562; H01M 10/0525; H01M 2300/008

(57) ABSTRACT

The present invention relates to a solid electrolyte, a method for manufacturing the same, and a lithium secondary battery comprising the same.

The sulfide-based solid electrolyte according to the present invention is represented by Chemical Formula 1 below.

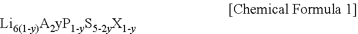

In Chemical Formula 1, A is a group IIIA element (boron group element), X is a halogen element, and 0<y≤1.

### FIELD OF THE INVENTION

The present invention relates to a solid electrolyte, a method of preparing the same, and a lithium secondary battery comprising the same. More particularly, the present invention relates to a sulfide-based solid electrolyte doped with a group 13 element.

### DESCRIPTION OF THE RELATED ART

All-solid-state batteries are batteries in which the electrolyte is in a solid state. All-solid-state batteries replace flammable liquid electrolytes with solid electrolytes, thereby offering improved safety and reduced risk of explosion. Accordingly, all-solid-state batteries comprising solid electrolytes are attracting attention as next-generation batteries.

In particular, sulfide-based solid electrolytes exhibit superior ionic conductivity compared to other solid electrolytes such as polymer- or oxide-based electrolytes. Since the ionic conductivity of sulfide-based solid electrolytes is comparable to that of liquid electrolytes, all-solid-state batteries employing sulfide-based solid electrolytes are considered the most practical candidates among all-solid-state battery technologies.

Specifically, Li₆PS₅X, which has an argyrodite structure, exhibits high ionic conductivity and excellent stability, and is therefore widely used as a solid electrolyte by various institutions.

For commercialization of batteries, evaluation must be conducted in a full-cell configuration. However, when solid electrolytes having an argyrodite structure are evaluated in full-cell type all-solid-state batteries, their performance is inferior compared to that of conventional commercial lithium-ion batteries. This is because solid electrolytes with an argyrodite structure exhibit higher resistance and still relatively low ionic conductivity compared to currently used liquid electrolytes. In other words, the high resistance and low ionic conductivity result in inferior cell characteristics.

Therefore, there is a need to improve the ionic conductivity of solid electrolytes having an argyrodite structure. Enhancing the ionic conductivity of solid electrolytes may improve the performance of all-solid-state batteries and accelerate their commercialization.

### SUMMARY OF THE INVENTION

### Technical Problem

The present invention is directed to providing a solid electrolyte, a method of preparing the same, and a lithium secondary battery comprising the same. More specifically, the present invention is directed to providing a sulfide-based solid electrolyte doped with a group 13 element.

### Technical Solution

The sulfide-based solid electrolyte according to the present invention is represented by Chemical Formula 1:

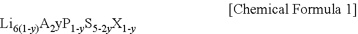

In Chemical Formula 1, A is a group 13 element, X is a halogen element, and 0<y≤1.

A may be at least one selected from the group consisting of boron (B), aluminum (Al), gallium (Ga), indium (In), and thallium (Tl).

A may be boron (B).

y may be in a range from 0.02 to 0.16.

X may be at least one selected from the group consisting of fluorine (F), chlorine (Cl), bromine (Br), and iodine (I).

X may be chlorine (Cl).

The sulfide-based solid electrolyte according to the present invention may include a crystalline phase having an argyrodite-type crystal structure.

A method of preparing the sulfide-based solid electrolyte according to the present invention comprises: preparing a mixture comprising lithium sulfide (Li₂S), a sulfur compound, a halogen compound, and a compound comprising a group 13 element; and calcining the mixture.

In the step of preparing the mixture comprising lithium sulfide (Li₂S), a sulfur compound, a halogen compound, and a compound comprising a group 13 element, the compound comprising the group 13 element may be B₂S₃.

In the step of preparing the mixture comprising lithium sulfide (Li₂S), a sulfur compound, a halogen compound, and a compound comprising a group 13 element, the concentration of the compound comprising the group 13 element may be from 0.02 mol % to 0.16 mol %.

In the step of preparing the mixture comprising lithium sulfide (Li₂S), a sulfur compound, a halogen compound, and a compound comprising a group 13 element, the sulfur compound may be phosphorus pentasulfide (P₂S₅).

In the step of preparing the mixture comprising lithium sulfide (Li₂S), a sulfur compound, a halogen compound, and a compound comprising a group 13 element, the halogen compound may be LiX, wherein X is at least one selected from the group consisting of fluorine (F), chlorine (Cl), bromine (Br), and iodine (I).

A lithium secondary battery according to the present invention comprises a positive electrode, a negative electrode, and a solid electrolyte layer positioned between the positive electrode and the negative electrode, wherein at least one of the positive electrode, the negative electrode, or the solid electrolyte layer comprises the sulfide-based solid electrolyte according to the present invention.

### Advantageous Effects

The sulfide-based solid electrolyte according to the present invention is doped with boron, which improves the mobility of lithium ions, thereby providing high ionic conductivity and excellent cell capacity characteristics.

### DETAILED DESCRIPTION OF THE EMBODIMENTS

The terms such as “first,” “second,” and “third” may be used to describe various components, elements, regions, layers, and/or sections, but are not limited thereto. These terms are merely used to distinguish one component, element, region, layer, or section from another. Therefore, a first component, element, region, layer, or section described below may be referred to as a second component, element, region, layer, or section within the scope of the present invention.

The terminology used herein is intended only to describe specific embodiments and is not intended to limit the scope of the present invention. As used herein, the singular forms “a,” “an,” and “the” are intended to include the plural forms as well, unless the context clearly indicates otherwise. The term “comprising/including/involving/containing/having” as used in the specification is intended to specify the presence of stated features, regions, integers, steps, operations, elements, and/or components, but does not preclude the presence or addition of one or more other features, regions, integers, steps, operations, elements, and/or components.

When a component is referred to as being “on” or “above/over” another component, it may be directly on or over the other component, or intervening components may be present therebetween. In contrast, when a component is referred to as being “directly on” or “directly above/over” another component, no intervening components are present.

Unless otherwise defined, all technical and scientific terms used herein have the same meaning as commonly understood by one of ordinary skill in the art to which this invention belongs. Commonly used terms that are defined in generally accepted dictionaries should be interpreted as having meanings that are consistent with their use in the relevant technical field and the context of the present disclosure, and are not to be interpreted in an idealized or overly formal sense unless expressly so defined.

The sulfide-based solid electrolyte according to the present invention has been developed to improve the low ionic conductivity of conventional undoped sulfide-based solid electrolytes and to enhance the cell characteristics of batteries comprising such solid electrolytes.

More specifically, the invention is directed to improving the ionic conductivity and cell performance of a solid electrolyte represented by Li₆PS₅X, where X denotes a halogen element.

The sulfide-based solid electrolyte according to the present invention is represented by the following Chemical Formula 1:

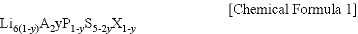

In Chemical Formula 1, A is a group 13 element, X is a halogen element, and 0<y≤1.

The sulfide-based solid electrolyte according to the present invention may be a doped version of the solid electrolyte represented by Li₆PS₅X, in which a group 13 element is doped. More specifically, it may be a doped solid electrolyte represented by Li₆PS₅Cl, wherein boron (B) is doped.

More specifically, A may be a group 13 element. Still more specifically, A may be at least one selected from the group consisting of boron (B), aluminum (Al), gallium (Ga), indium (In), and thallium (Ti). Most preferably, A may be boron (B).

The group 13 element may serve as a dopant. In the present specification, the term “doping” may encompass not only the substitution of an existing element in a compound with a new element, but also inclusion of the doped element as a constituent of the crystal phase of the compound.

Doping with a group 13 element within the crystal structure of the solid electrolyte may induce lithium-ion deficiency in the existing lattice. Such lithium-ion deficiency results in the formation of vacancies, which facilitates easier migration of lithium ions. As a result, the ionic conductivity of the solid electrolyte may be improved.

In one embodiment of the present invention, since lithium ion deficiency may occur, the term 6(1-y) in Chemical Formula 1 represents the molar quantity of lithium (Li). In this context, 6(1-y) may range from 5 to 6, more specifically from 5 to 5.6, still more specifically from 5 to 5.5, and even more specifically from 5.2 to 5.45.

Meanwhile, 2y in Chemical Formula 1 represents the molar quantity of the doped group 13 element. In this case, y satisfies 0<y≤1.

More specifically, y may range from 0.02 to 0.16. If y is too small, it indicates an insufficient amount of dopant, whereas an excessively large y indicates excessive doping. In both cases, the ionic conductivity of the solid electrolyte may deteriorate, leading to poor cell performance. That is, if the doping amount of the group 13 element is too low, it does not significantly deviate from the base Li₆PS₅Cl argyrodite composition, resulting in insufficient vacancy formation and no doping effect. Conversely, excessive doping may severely distort the argyrodite crystal structure of the sulfide-based solid electrolyte, thereby impeding lithium-ion transport.

More specifically, y may range from 0.07 to 0.16, still more specifically from 0.08 to 0.16, more preferably from 0.09 to 0.13, and most preferably from 0.10 to 0.12 or from 0.11 to 0.13.

In Chemical Formula 1, X is a halogen element, and may be at least one selected from the group consisting of fluorine (F), chlorine (Cl), bromine (Br), and iodine (I). More specifically, X may be chlorine (Cl).

The sulfide-based solid electrolyte according to the present invention may include a crystalline phase having an argyrodite-type crystal structure. The argyrodite-type structure is advantageous in that it provides high ionic conductivity.

The method of preparing a sulfide-based solid electrolyte according to the present invention comprises: preparing a mixture comprising lithium sulfide (Li₂S), a sulfur compound, a halogen compound, and a compound comprising a group 13 element; and calcining the mixture.

Hereinafter, the method for preparing the sulfide-based solid electrolyte according to the present invention will be described step by step.

First, a mixture is prepared using lithium sulfide (Li₂S), a sulfur compound, a halogen compound, and a compound comprising a group 13 element. That is, these components are used as raw materials for synthesizing the sulfide-based solid electrolyte.

The sulfur compound may be a compound in which sulfur (S) is combined with one or more elements selected from the group consisting of phosphorus (P), silicon (Si), germanium (Ge), aluminum (Al), boron (B), and mixtures thereof. More specifically, the sulfur compound may be phosphorus pentasulfide (P₂S₅).

The halogen compound may be represented by LiX, where X is a halogen element. X may be at least one selected from the group consisting of fluorine (F), chlorine (Cl), bromine (Br), and iodine (I). Accordingly, the halogen compound may be one or more selected from LiF, LiCl, LiBr, and LiI.

The compound comprising a group 13 element may be represented by A₂S₃, where A is a group 13 element. More specifically, A may be at least one selected from the group consisting of boron (B), aluminum (Al), gallium (Ga), indium (In), and thallium (Tl). Even more specifically, the compound may be B₂S₃.

In this step, the concentration of the compound comprising the group 13 element may be from 0.02 mol % to 0.16 mol %. If the doping amount is too low, insufficient vacancies are formed and no doping effect is observed. If it is too high, the argyrodite crystal structure of the sulfide-based solid electrolyte may be significantly distorted, thereby impeding lithium ion migration.

More specifically, the concentration of the compound comprising the group 13 element (i.e., the value y) may range from 0.07 mol % to 0.16 mol %, still more preferably from 0.08 mol % to 0.16 mol %, even more preferably from 0.09 mol % to 0.13 mol %, and most preferably from 0.10 mol % to 0.12 mol % or 0.11 mol % to 0.13 mol %.

For example, when B₂S₃ is added to Li₆PS₅X to prepare a B-doped sulfide-based solid electrolyte, the synthesis reaction may be represented by Reaction Scheme 1:

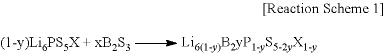

The mixing of raw materials may be carried out by either dry or wet methods. More specifically, dry milling may be employed.

The dry milling may be performed using a ball mill, vibration mill, turbo mill, mechanofusion system, disk mill, bead mill, or planetary mill. Most preferably, a planetary mill is used.

The dry milling may be carried out for 5 to 12 hours, and more preferably for 6 to 10 hours. Insufficient milling time may lead to inadequate mixing, while excessive milling beyond a certain threshold does not further improve the homogeneity and is therefore not preferred from a productivity standpoint.

The rotation speed of the planetary mill may be in the range of 150 to 450 rpm, more preferably 200 to 400 rpm. If the rotation speed is too low, the balls inside the mill may not adequately penetrate the powder bed, leading to poor dispersion or insufficient particle refinement. On the other hand, if the speed is too high, the powder may accumulate in localized regions, leading to non-uniform mixing.

Next, the mixture may be pelletized. The pressure for forming the pellet may be in the range of 150 MPa to 450 MPa, more preferably from 200 MPa to 400 MPa. If the pressure is too low, insufficient interparticle bonding may result in high interfacial resistance. If the pressure exceeds a certain level, further increases do not improve bonding, so applying an appropriate pressure is desirable from a productivity standpoint.

Thereafter, the pelletized mixture is calcined to prepare the solid electrolyte.

The calcination may be performed at a temperature ranging from 200° C. to 700° C., more preferably from 300° C. to 600° C. If the temperature is too low, the heat treatment is ineffective. If the temperature is too high, volatile components in the solid electrolyte may be lost due to evaporation.

The calcination may be conducted under an inert gas atmosphere, more preferably under argon (Ar).

Additionally, the synthesized solid electrolyte may be crushed and pelletized again to fabricate a test cell using working electrodes.

A lithium secondary battery according to the present invention includes a positive electrode, a negative electrode, and a solid electrolyte layer positioned between the positive electrode and the negative electrode, wherein at least one of the positive electrode, the negative electrode, or the solid electrolyte layer comprises the sulfide-based solid electrolyte described above.

The positive electrode may comprise a positive electrode active material, a conductive agent, a binder, and optionally the above-described solid electrolyte.

The negative electrode may be a metal anode or a composite anode. The composite anode may include a negative electrode active material, a conductive agent, a binder, and optionally the solid electrolyte.

Details regarding the sulfide-based solid electrolyte have been described above and will not be repeated here for brevity.

### DETAILED DESCRIPTION OF THE EMBODIMENTS

Hereinafter, embodiments of the present invention will be described in detail. However, the following examples are provided for illustrative purposes only and are not intended to limit the scope of the present invention, which is defined solely by the appended claims.

### Comparative Example 1—No B₂S₅ Addition

### (1) Synthesis of Solid Electrolyte

The solid electrolyte was synthesized using a dry milling method. Lithium sulfide (Li₂S), phosphorus pentasulfide (P₂S₅), and lithium chloride (LiCl) were mixed using a planetary mill at 300 rpm for approximately 8 hours. Subsequently, a pellet was formed under a pressure of 300 MPa. The pellet was then heat-treated at 500° C. under an argon (Ar) atmosphere to synthesize Li₆PS₅Cl.

### (2) Measurement of Ionic Conductivity

The synthesized solid electrolyte was crushed and pelletized under a pressure of 300 MPa. A cell was fabricated using SUS as a working electrode. The ionic conductivity of the cell was measured via impedance spectroscopy.

The results are shown in Table 1 below.

### Example 1—Addition of 0.02 Mol % B₂S₅

Except for additionally adding 0.02 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 2—Addition of 0.04 Mol % B₂S₅

Except for additionally adding 0.04 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 3—Addition of 0.06 Mol % B₂S₅

Except for additionally adding 0.06 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 4—Addition of 0.08 Mol % B₂S₅

Except for additionally adding 0.08 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 5—Addition of 0.10 Mol % B₂S₅

Except for additionally adding 0.10 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 6—Addition of 0.12 Mol % B₂S₅

Except for additionally adding 0.12 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 7—Addition of 0.14 Mol % B₂S₅

Except for additionally adding 0.14 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 8—Addition of 0.16 Mol % B₂S₅

Except for additionally adding 0.16 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 9—Addition of 0.18 Mol % B₂S₅

Except for additionally adding 0.18 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

### Example 10—Addition of 0.20 Mol % B₂S₅

Except for additionally adding 0.20 mol % of B₂S₅ during the mixing process of Comparative Example 1, the solid electrolyte was synthesized under the same conditions as Comparative Example 1.

The synthesized B-doped solid electrolyte was used to fabricate a cell in the same manner as in Comparative Example 1, and the ionic conductivity was measured using the same method. The results are shown in Table 1 below.

TABLE 1

| | | B₂S₃ | Ionic Conductivity |
|---|---|---|---|
| Example | Composition | (mol %) | (mS/cm) |
| Comparative Example 1 | Li₆PS₅Cl | — | 3.2 |
| Example 1 | Li_{5.88}B_{0.04}P_{0.98}S_{4.96}Cl_{0.98} | 0.02 | 3.4 |
| Example 2 | Li_{5.76}B_{0.08}P_{0.96}S_{4.92}Cl_{0.96} | 0.04 | 3.7 |
| Example 3 | Li_{5.64}B_{0.12}P_{0.94}S_{4.88}Cl_{0.94} | 0.06 | 3.9 |
| Example 4 | Li_{5.52}B_{0.16}P_{0.92}S_{4.84}Cl_{0.92} | 0.08 | 4.2 |
| Example 5 | Li_{5.4}B_{0.2}P_{0.9}S_{4.8}Cl_{0.9} | 0.1 | 4.75 |
| Example 6 | Li_{5.28}B_{0.24}P_{0.88}S_{4.76}Cl_{0.88} | 0.12 | 4.72 |
| Example 7 | Li_{5.16}B_{0.28}P_{0.86}S_{4.72}Cl_{0.86} | 0.14 | 4.65 |
| Example 8 | Li_{5.04}B_{0.32}P_{0.84}S_{4.68}Cl_{0.84} | 0.16 | 4.6 |
| Example 9 | Li_{4.92}B_{0.36}P_{0.82}S_{4.64}Cl_{0.82} | 0.18 | 3.1 |
| Example 10 | Li_{4.8}B_{0.4}P_{0.8}S_{4.6}Cl_{0.8} | 0.2 | 2.8 |

The ionic conductivity of the cells comprising the sulfide-based solid electrolytes prepared in Comparative Example 1 and Examples 1 to 10 was compared.

It was found that the solid electrolyte of Example 1, in which 0.02 mol % of B₂S₅ was added to dope B, exhibited higher ionic conductivity than that of Comparative Example 1, in which no B doping was performed. From the fact that a small amount of B doping resulted in higher ionic conductivity than the non-doped case, it can be understood that B doping fundamentally improves the ionic conductivity of the cell.

Furthermore, in Examples up to Example 5, in which 0.10 mol % of B₂S₅ was added, the ionic conductivity increased as the B doping concentration increased.

In particular, Examples 4, 5, 6, 7, and 8—wherein 0.08 mol %, 0.10 mol %, 0.12 mol %, 0.14 mol %, and 0.16 mol % of B₂S₅ were added, respectively—exhibited ionic conductivity values exceeding 4 mS/cm.

Additionally, Example 5, in which 0.10 mol % of B₂S₅ was added, exhibited the highest ionic conductivity of 4.75 mS/cm.

It should be understood that the present invention is not limited to the above-described examples, but may be embodied in various other forms. It will be apparent to those skilled in the art to which the present invention pertains that various modifications can be made without departing from the spirit or essential characteristics of the present invention. Therefore, the above examples should be understood as illustrative in all respects and not as limiting.

What is claimed is:

1. A sulfide-based solid electrolyte represented by Chemical Formula 1: 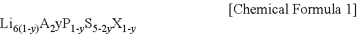
wherein A is a group 13 element, X is a halogen element, and 0<y≤1.

2. The sulfide-based solid electrolyte of claim 1,
wherein A is at least one selected from the group consisting of boron (B), aluminum (Al), gallium (Ga), indium (In), and thallium (Tl).

3. The sulfide-based solid electrolyte of claim 2,
wherein A is boron (B).

4. The sulfide-based solid electrolyte of claim 1,
wherein y is in a range from 0.02 to 0.16.

5. The sulfide-based solid electrolyte of claim 1,
wherein X is at least one selected from the group consisting of fluorine (F), chlorine (Cl), bromine (Br), and iodine (I).

6. The sulfide-based solid electrolyte of claim 5,
wherein X is chlorine (Cl).

7. The sulfide-based solid electrolyte of claim 1,
wherein the sulfide-based solid electrolyte comprises a crystal phase having an argyrodite-type crystal structure.

8. A method for preparing a sulfide-based solid electrolyte, comprising:
preparing a mixture comprising lithium sulfide (Li₂S), a sulfur compound, a halogen compound, and a compound comprising a group 13 element; and
calcining the mixture.

9. The method of claim 8,
wherein, in the step of preparing the mixture comprising lithium sulfide (Li₂S), a sulfur compound, a halogen compound, and a compound comprising a group 13 element,
the compound comprising the group 13 element is B₂S₃.

10. The method of claim 8,
wherein, in the step of preparing the mixture comprising lithium sulfide (Li₂S), a sulfur compound, a halogen compound, and a compound comprising a group 13 element,
the concentration of the compound comprising the group 13 element is from 0.02 mol % to 0.16 mol %.

11. The method of claim 8,
wherein the sulfur compound is P₂S₅.

12. The method of claim 8,
wherein the halogen compound is LiX,
and X is at least one selected from the group consisting of fluorine (F), chlorine (Cl), bromine (Br), and iodine (I).

13. A lithium secondary battery comprising a positive electrode, a negative electrode, and a solid electrolyte layer positioned between the positive electrode and the negative electrode,
wherein at least one of the positive electrode, the negative electrode, or the solid electrolyte layer comprises the solid electrolyte of claim 1.
